(19) United States
(12) Patent Application Publication
(10) Pub. No.: US 2004/0039106 A1
(43) Pub. Date: Feb. 26, 2004

(54) Conformable calendered films and articles made therefrom

(76) Inventors: Aren Joost de Man, Leiderdorp (NL); Chan U. Ko, Arcadia, CA (US); Sam de Visser, Boskopp (NL)

Correspondence Address: Heidi A. Boehlefeld, Renner, Otto, Boisselle & Sklar, LLP, Nineteenth Floor, 1621 Euclid Avenue, Cleveland, OH, 44115-2191, US

(21) Appl. No.: 10/464,605

(22) Filed: Jun. 18, 2003

Related U.S. Application Data
(60) Provisional application No. 60/392,324, filed on Jun. 27, 2002.

(51) Int. Cl. C08K 5/10

(52) U.S. Cl. 524/525; 524/297; 524/315

(57) ABSTRACT

This invention relates to a calendered vinyl halide film comprising (A) at least one vinyl halide polymer, (B) at least one non-halogenated polymeric plasticizer and (C) at least one second plasticizer different from the non-halogenated polymeric plasticizer, wherein a major amount of the polymers of the film comprise the vinyl halide polymer (A) and wherein the film has an elongation of at least about 50%. The invention also relates to an adhesive article comprising a pressure sensitive adhesive layer having a first and second surface, and a calendered vinyl halide film adhered to the first surface of the adhesive layer, wherein the vinyl halide film comprises (A) at least one vinyl halide polymer, (B) at least one non-halogenated polymeric plasticizer and (C) at least one second plasticizer, wherein the adhesive article has an elongation of at least about 50%. The film and subsequent articles derived therefrom have improved conformability. The films and articles are useful in exterior graphics applications, including graphics for vehicles, especially vehicles with corrugated side panels.

This application claims the benefit of provisional application No. 60/392,324 filed Jun. 27, 2002.

### FIELD OF THE INVENTION

This invention relates to films that have a high degree of conformability. The calendered films are useful in graphics applications, especially in exterior graphics applications.

### BACKGROUND OF THE INVENTION

The vinyl films plasticized with plasticizers have been used for many years as decorative sheets for trucks. Polymeric films have had wide acceptance for such applications because, among other things, they are inexpensive and weather resistant and can be colored easily with pigments and dyes. In addition, plasticized polyvinylchloride (PVC) has had particularly wide acceptance because its properties can be modified over a wide range by incorporation of plasticizers. The challenge of the graphic marking film is for the application of large format graphics onto commercial vehicles or vans with deep/corrugated body panels. Additional plasticizers can be added to the PVC formulation to make the film soft and flexible, but too much plasticizer in the formulation can be a problem because of the migration of the plasticizer into the adhesive coating. The adhesive properties are adversely affected or destroyed as the plasticizer migrates from the polyvinyl chloride into the adhesive coating.

The present invention involves the use of polymeric materials to plasticize the PVC film to make it flexible for increased conformability over the corrugations and into the recessed areas of van/truck body panels, as well as other non-planar surfaces.

### SUMMARY OF THE INVENTION

This invention relates to a calendered vinyl halide film comprising (A) at least one vinyl halide polymer, (B) at least one non-halogenated polymeric plasticizer and (C) at least one second plasticizer different from the non-halogenated polymeric plasticizer, wherein a major amount of the polymers of the film comprise the vinyl halide polymer (A) and wherein the film has an elongation of at least about 50%. The invention also relates to an adhesive article comprising a pressure sensitive adhesive layer having a first and second surface, and a calendered vinyl halide film adhered to the first surface of the adhesive layer, wherein the vinyl halide film comprises (A) at least one vinyl halide polymer, (B) at least one non-halogenated polymeric plasticizer and (C) at least one second plasticizer, wherein the adhesive article has an elongation of at least about 50%.

The film and subsequent articles derived therefrom have improved conformability. The films and articles are useful in exterior graphics applications, including graphics for vehicles, especially vehicles with corrugated side panels. The films have good elongation properties and conformability.

### BRIEF DESCRIPTION OF THE DRAWINGS

FIG. 1 is a schematic diagram illustrating a calendering process for making the conformable films of the present invention.

### DETAILED DESCRIPTION OF THE PREFERRED EMBODIMENTS

The calendered films and articles of the present invention are useful for graphics applications. They may be used in both interior and exterior graphics applications, but are particularly useful in exterior applications. Additionally, these films and articles are particularly useful in large graphics applications. One of the difficulties of applying a film or adhesive article to a large application area is the inability of the graphic to conform to the substrate. This is especially true when the substrate has a non-planar surface. For example, the side panel of trucks, in particular heavy construction trucks, have multiple corrugations to provide enhanced side panel support. To apply a typical graphic film to the panel, the graphic film must conform through elongation to achieve adherence to the corrugated surface. Without good adherence, the graphic film will lack integrity. Weather conditions may also cause the failure of a graphic film having poor conforming adherence. Additionally, the graphic, if not properly conformable, will have poor aesthetic appearance.

As described above, the invention relates to a calendered vinyl halide film comprising (A) at least one vinyl halide polymer, (B) at least one non-halogenated polymeric plasticizer and (C) at least one second plasticizer, wherein a major amount of the polymers of the film comprise the vinyl halide polymer (A) and wherein the film has an elongation of at least about 50%. The vinyl halide film generally has a thickness from about 1 to about 20, or from about 1.5 to about 15, or from 1.8 to about 6 mils. Here and elsewhere in the specification and claims, the range and ratio limits may be combined. The vinyl halide film has an elongation of at least about 50%, at least about 55%, at least about 65%, or at least about 75%.

Vinyl Halide Polymer

The calendered vinyl halide film includes at least one vinyl halide polymer. The vinyl halide polymer is present as a major amount of the polymers present in the film. The vinyl halide polymers include homopolymers or copolymers of vinyl chloride. The vinyl halide films include those derived from vinyl bromide, vinyl chloride or vinyl fluoride. Examples of these films include polyvinylchloride and polyvinylfluoride films. The polyvinylchloride resins (sometimes referred to herein as PVC resins) are well known and include both homopolymers of vinyl chloride and copolymers of vinyl chloride with a minor amount by weight of one or more ethylenically-unsaturated comonomers that are copolymerizable with the vinyl chloride. Examples of such ethylenically-unsaturated comonomers include vinyl halides such as vinyl fluoride and vinyl bromide; alpha-olefins such as ethylene, propylene and butylene; vinyl esters such as vinyl acetate, vinyl propionate, vinyl butyrate and vinyl hexanoate, or partially hydrolyzed products thereof such as vinyl alcohol; vinyl ethers such as methyl vinyl ether, propyl vinyl ether and butyl vinyl ether; acrylic esters such as methyl acrylate, ethyl acrylate, methyl methacrylate and butyl methacrylate and other monomers such as acrylonitrile, vinylidene chloride and dibutyl maleate. Such resins are generally known and many are commercially available. In one embodiment, the vinyl film is a homopolymer of vinyl chloride.

Examples of polyvinylchloride resins that are commercially available include GEON® polyvinylchlorides available from BF Goodrich Company, POLYVIN polyvinylchlorides available from A. Schulman, and UNICHEM polyvinylchlorides available from Colroite Plastics.

In one embodiment, the polyvinylchlorides have a K-value of from about 50 to about 90, or from about 55 to about 85, or from about 60 to about 82. The polyvinylchlorides, in another embodiment, have an inherent viscosity (ASTM D-1243-60-A) of from about 0.8 to about 1.8, or from about 0.9 to about 1.5, or from about 1 to about 1.3. In another embodiment, the polyvinylchlorides have a specific gravity of about 0.9 to about 1.8, or from about 1.2 to about 1.6. In another embodiment, the number average molecular weight of the PVC resins useful in the present invention range from about 20,000 up to about 80,000, and in another embodiment, from about 40,000 to about 60,000.

Plasticizers

The calendered vinyl halide film contains at least two plasticizers. One plasticizer is (B) a non-halogenated polymeric plasticizer. The other plasticizer is (C) a second plasticizer. A combination of non-halogenated plasticizers and second plasticizers may be used. For example, the calendered vinyl film may contain two non-halogenated plasticizers and a second plasticizer. The total plasticizer content typically contains up to 50% of the non-halogenated plasticizer. Typically, the non-halogenated plasticizer is present in an amount of less than about 30%, or less that about 20% or less than 15% of the total amount of the plasticizers in the film. In one embodiment, the non-halogenated plasticizer is present in an amount of less than 5%, or less that 4% of the total plasticizers in the film.

Non-Halogenated Plasticizer

The non-halogenated polymeric plasticizer (B) may be a single polymer or a combination of two or more polymers. The non-halogenated polymeric plasticizer is present in an amount of less than about 20 parts per hundred parts of the vinyl halide polymer (A). Generally, the non-halogenated polymeric plasticizer is present in an amount from about 0.5 to about 18, or from 1 to about 15, or from about 1.5 to about 8 parts per hundred parts of the vinyl halide polymer (A). The non-halogenated plasticizers are those polymers that provide plasticizing properties to the composition. In one embodiment, the non-halogenated plasticizers are those having a T_{g} of −18° C. or below. In one embodiment, the non-halogenated plasticizers have a T_{g} of −20° C., or −25° C., or −30° C., or below. In one embodiment, the non-halogenated polymeric plasticizers are liquid.

In one embodiment, the non-halogenated polymeric plasticizer (B) is a natural or synthetic thermoplastic elastomer, including synthetic or natural rubbers. Various thermoplastic elastomers can be utilized. Commercially available thermoplastic elastomers (TPE) are either block copolymers (e.g., styrenics, copolyesters, polyurethanes and polyamides) or elastomer/thermoplastic compositions such as thermoplastic elastomeric olefins (TEO) and thermoplastic vulcanizates (TPV).

In one embodiment, the thermoplastic elastomer may be a copolymer rubber of ethylene and an alpha-olefin containing from 3 to about 18 carbon atoms such as propylene, 1-butene, 1-pentene, etc. Alpha-olefins of from 3 to 6 carbon atoms are useful due to economic considerations, and generally the copolymers are those comprised of ethylene and propylene.

The copolymers of ethylene and other alpha-olefins such as propylene may contain other polymerizable monomers. Typical of these other monomers may be non-conjugated dienes such as the following non-limiting examples:

(a) straight chain acyclic dienes such as: 1,4-hexadiene, and 1,6-octadiene;

(b) branched chain acyclic dienes such as: 5-methyl-1,4-hexadiene, and 3,7-dimethyl-1,6-octadiene;

(c) single ring alicyclic dienes such as: 1,4-cyclohexadiene, and 1,5-cyclooctadiene; and

(d) multi-ring alicyclic fused and bridged ring diene such as: tetrahydroindene, dicyclopentadiene, bicyclo-2,2,1-hepta-2,5-diene, norbornenes such as 5-methylene-2-norbornene (MNB), 5-ethylidene-2-norbornene (ENB), and 5-propylene-2-norbornene (PNB).

Of the non-conjugated dienes typically used to prepare such copolymers, dienes containing at least one of the double bonds in a strained ring are useful, and the most common of such dienes are dicyclopentadiene and 5-ethylidene-2-norbornene (ENB). The amount of the diene (on a weight basis) in the copolymer should be from 0% to about 20%, or from about 0.5% to about 10%.

Useful ethylene alpha-olefin copolymers for the invention are ethylene-propylene or ethylene-propylene-diene copolymers. In either event, the average ethylene content of the copolymer could be as low as about 20% and as high as 90% to 95% on a weight basis. The remainder is either propylene or diene. In one embodiment, the copolymers will contain from about 50% or 60% by weight up to about 80% by weight of ethylene.

The ethylene-based copolymers are generally characterized by a Mooney viscosity, ML (1+4) 100° C. of between 10 and 100, or between about 20 to about 80, and a specific gravity of from 0.85 to about 0.88 g/cc.

The ethylene, alpha-olefin copolymers are available commercially from a variety of sources. For example, a variety of ethylene/propylene copolymers are available from Polysar Corp. (Bayer) under the general trade designation “POLYSAR.” Particular examples include POLYSAR EPM 306 which is an ethylene/propylene copolymer containing 68 weight percent ethylene and 32 weight percent propylene; POLYSAR EPDM 227 is a copolymer of ethylene, propylene and 3% ENB wherein the ethylene/propylene ratio is 75/25. An example of a copolymer containing a smaller amount of ethylene is POLYSAR EPDM 345 which contains 4% ENB and the weight ratio of ethylene/propylene is 60/40. Bayer XF-004 is an experimental EPDM containing 65 weight percent of ethylene, 32% by weight of propylene and 3% by weight of norbornenediene (NB). Another group of ethylene/propylene rubbers are available from Bayer under the general trade designation “BUNA AP.” In particular, BUNA AP301 is an ethylene/propylene copolymer containing 51% ethylene and 49% propylene; BUNA AP147 is a copolymer containing 4% ENB and the weight ratio of ethylene/propylene is 73/27.

Ethylene/propylene rubbers are also available from Exxon Chemical Company. One example is VISTALON 719, which has a typical ethylene content of 75%, a typical Mooney viscosity (at 127° C.) of 54, and a specific gravity of 0.87.

In one embodiment, the vinyl halide films may be prepared utilizing thermoplastic elastomer materials such as block copolymers represented by the diblock structures A-B, the triblock A-B-A, the radial or coupled structures (A-B)ₙ, and combinations of these where A represents a hard thermoplastic phase or block which is non-rubbery or glassy or crystalline at room temperature but fluid at higher temperatures, and B represents a soft block which is rubbery or elastomeric at service or room temperature. These thermoplastic elastomers may comprise from about 40% to about 95% by weight of rubbery segments and from about 5% to about 60% by weight of non-rubbery segments.

The non-rubbery segments or hard blocks comprise polymers of mono- and polycyclic aromatic hydrocarbons, and more particularly vinyl-substituted aromatic hydrocarbons that may be monocyclic or bicyclic in nature. The useful rubbery blocks or segments are polymer blocks of homopolymers or copolymers of aliphatic conjugated dienes. Rubbery materials such as polyisoprene, polybutadiene, and styrene butadiene rubbers may be used to form the rubbery block or segment. Useful rubbery segments include polydienes and saturated olefin rubbers of ethylene/butylene or ethylene/propylene copolymers. The latter rubbers may be obtained from the corresponding unsaturated polyalkylene moieties such as polybutadiene and polyisoprene by hydrogenation thereof.

The block copolymers of vinyl aromatic hydrocarbons and conjugated dienes that may be used include any of those that exhibit elastomeric properties. The block copolymers may be diblock, triblock, multiblock, starblock, polyblock or graftblock copolymers. Throughout this specification and claims, the terms diblock, triblock, multiblock, polyblock, and graft or grafted-block with respect to the structural features of block copolymers are to be given their normal meaning as defined in the literature such as in the Encyclopedia of Polymer Science and Engineering, Vol. 2, (1985) John Wiley & Sons, Inc., New York, pp. 325-326, and by J. E. McGrath in Block CoPolymers, Science Technology, Dale J. Meier, Ed., Harwood Academic Publishers, 1979, at pages 1-5.

Such block copolymers may contain various ratios of conjugated dienes to vinyl aromatic hydrocarbons including those containing up to about 60% by weight of vinyl aromatic hydrocarbon. Accordingly, multi-block copolymers may be utilized which are linear or radial symmetric or asymmetric and which have structures represented by the formulae A-B, A-B-A, A-B-A-B, B-A-B, (AB)_{0,1,2 . . .} BA, etc., wherein A is a polymer block of a vinyl aromatic hydrocarbon or a conjugated diene/vinyl aromatic hydrocarbon tapered copolymer block, and B is a rubbery polymer block of a conjugated diene.

The block copolymers may be prepared by any of the well-known block polymerization or copolymerization procedures including sequential addition of monomer, incremental addition of monomer, or coupling techniques as illustrated in, for example, U.S. Pat. Nos. 3,251,905; 3,390,207; 3,598,887; and 4,219,627. As is well known, tapered copolymer blocks can be incorporated in the multi-block copolymers by copolymerizing a mixture of conjugated diene and vinyl aromatic hydrocarbon monomers utilizing the difference in their copolymerization reactivity rates. Various patents describe the preparation of multi-block copolymers containing tapered copolymer blocks including U.S. Pat. Nos. 3,251,905; 3,639,521; and 4,208,356, the disclosures of which are hereby incorporated by reference.

Conjugated dienes that may be used to prepare the polymers and copolymers are those containing from 4 to about 10 carbon atoms and more generally, from 4 to 6 carbon atoms. Examples include from 1,3-butadiene, 2-methyl-1,3-butadiene (isoprene), 2,3-dimethyl-1,3-butadiene, chloroprene, 1,3-pentadiene, 1,3-hexadiene, etc. Mixtures of these conjugated dienes also may be used. Useful conjugated dienes are isoprene and 1,3-butadiene.

Examples of vinyl aromatic hydrocarbons that may be used to prepare the copolymers include styrene and the various substituted styrenes such aso-methylstyrene, p-methylstyrene, p-tert-butylstyrene, 1,3-dimethylstyrene, alpha-methylstyrene, beta-methylstyrene, p-isopropylstyrene, 2,3-dimethylstyrene, o-chlorostyrene, p-chlorostyrene, o-bromostyrene, 2-chloro-4methylstyrene, etc. A useful vinyl aromatic hydrocarbon is styrene.

Many of the above-described copolymers of conjugated dienes and vinyl aromatic compounds are commercially available. The number average molecular weight of the block copolymers, prior to hydrogenation, is from about 20,000 to about 500,000, or from about 40,000 to about 300,000.

The average molecular weights of the individual blocks within the copolymers may vary within certain limits. In most instances, the vinyl aromatic block will have a number average molecular weight in the order of about 2000 to about 125,000, and or between about 4000 and 60,000. The conjugated diene blocks either before or after hydrogenation will have number average molecular weights in the order of about 10,000 to about 450,000 and or from about 35,000 to 150,000.

In one embodiment, prior to hydrogenation, the vinyl content of the conjugated diene portion generally is from about 10% to about 80%, and the vinyl content is from about 25% to about 65%, or about 35% to about 55% when it is desired that the modified block copolymer exhibit rubbery elasticity. The vinyl content of the block copolymer can be measured by means of nuclear magnetic resonance.

Specific examples of diblock copolymers include styrene-butadiene, styrene-isoprene, and the hydrogenated derivatives thereof. Examples of triblock polymers include styrene-butadiene-styrene (SBS), styrene-isoprene-styrene (SIS), alpha-methylstyrene-butadiene-alpha-methylstyrene, and alpha-methylstyreneisoprene alpha-methylstyrene. Upon hydrogenation of the SBS copolymers comprising a rubbery segment of a mixture of 1,4 and 1,2 isomers, a styrene-ethylene-butylene styrene (SEBS) block copolymer is obtained. Similarly, hydrogenation of an SIS polymer yields a styrene-ethylene propylene-styrene (SEPS) block copolymer.

The selective hydrogenation of the block copolymers may be carried out by a variety of well-known processes including hydrogenation in the presence of such catalysts as Raney nickel, noble metals such as platinum, palladium, etc., and soluble transition metal catalysts. Suitable hydrogenation processes that can be used are those wherein the diene-containing polymer or copolymer is dissolved in an inert hydrocarbon diluent such as cyclohexane and hydrogenated by reaction with hydrogen in the presence of a soluble hydrogenation catalyst. Such procedures are described in U.S. Pat. Nos. 3,113,986 and 4,226,952, the disclosures of which are incorporated herein by reference. Such hydrogenation of the block copolymers which are carried out in a manner and to extent as to produce selectively hydrogenated copolymers having a residual unsaturation content in the polydiene block from about 0.5% to about 20% of their original unsaturation content prior to hydrogenation.

In one embodiment, the conjugated diene portion of the block copolymer is at least 90% saturated and more often at least 95% saturated while the vinyl aromatic portion is not significantly hydrogenated. Hydrogenated block copolymers include hydrogenated products of the block copolymers of styrene-isoprene-styrene such as a styrene-(ethylene/propylene)-styrene block polymer. When a polystyrene-polybutadiene-polystyrene block copolymer is hydrogenated, it is desirable that the 1,2-polybutadiene to 1,4-polybutadiene ratio in the polymer is from about 30:70 to about 70:30. When such a block copolymer is hydrogenated, the resulting product resembles a regular copolymer block of ethylene and 1-butene (EB). As noted above, when the conjugated diene employed is isoprene, the resulting hydrogenated product resembles a regular copolymer block of ethylene and propylene (EP). A number of selectively hydrogenated block copolymers are available commercially from Shell Chemical Company under the general trade designation “Kraton.” One example is Kraton G-1652 which is a hydrogenated SBS triblock comprising about 30% by weight of styrene end blocks and a midblock which is a copolymer of ethylene and 1-butene (EB).

A lower molecular weight version of G1652 is available from Shell under the designation Kraton G1650. Kraton G1657 is a triblock copolymer which contains about 14% w styrene with polystyrene end blocks and a rubbery poly(ethylene-butene) midblock. This styrene content is lower than the styrene content in Kraton G1650 and Kraton G1652. Kraton GRP6598 is a styrene-ethylene/butylene-styrene block copolymer.

In another embodiment, the selectively hydrogenated block copolymer is of the formula: Bₙ(AB)ₒAₚ, wherein n=0 or 1; o is 1 to 100; p is 0 or 1; each B prior to hydrogenation is predominantly a polymerized conjugated diene hydrocarbon block having a number average molecular weight of about 20,000 to about 450,000; each A is predominantly a polymerized vinyl aromatic hydrocarbon block having a number average molecular weight of from about 2000 to about 115,000; the blocks of A constituting about 5% to about 95% by weight of the copolymer; and the unsaturation of the block B is less than about 10% of the original unsaturation. In other embodiments, the unsaturation of block B is reduced upon hydrogenation to less than 5% of its original value, and the average unsaturation of the hydrogenated block copolymer is reduced to less than 20% of its original value.

The polymeric plasticizer may also include functionalized polymers such as may be obtained by reacting an alpha, beta-olefinically unsaturated monocarboxylic or dicarboxylic acid reagent onto selectively hydrogenated block copolymers of vinyl aromatic hydrocarbons and conjugated dienes as described above. The reaction between the carboxylic acid reagent in the graft block copolymer can be effected in solutions or by a melt process in the presence of a free radical initiator.

The preparation of various selectively hydrogenated block copolymers of conjugated dienes and vinyl aromatic hydrocarbons which have been grafted with a carboxylic acid reagent is described in a number of patents including U.S. Pat. Nos. 4,578,429; 4,657,970; and 4,795,782, and the disclosures of these patents relating to grafted selectively hydrogenated block copolymers of conjugated dienes and vinyl aromatic compounds, and the preparation of such compounds are hereby incorporated by reference. U.S. Pat. No. 4,795,782 describes and gives examples of the preparation of the grafted block copolymers by the solution process and the melt process. U.S. Pat. No. 4,578,429 contains an example of grafting of Kraton G1652 (SEBS) polymer with maleic anhydride with 2,5-dimethyl-2,5-di(t-butylperoxy) hexane by a melt reaction in a twin screw extruder. (See Col. 8, lines 40-61.)

Examples of commercially available maleated selectively hydrogenated copolymers of styrene and butadiene include Kraton FG1901X and FG1921X from Shell, often referred to as maleated selectively hydrogenated SEBS copolymers. FG1901X contains about 2% w of maleic anhydride and 28% w of styrene. FG1921X contains about 1% w of maleic anhydride and 28% w of styrene.

Other TPEs that can be used to form the vinyl halide film layer include copolyesters that are also block copolymers with alternating hard polyalkylene terephthalate and soft polyalkylene ether segments or blocks. Thermoplastic polyurethane elastomers are block copolymers with soft segments comprising a polyester or polyether macroglycol, and hard segments which result from the reaction of lower molecular weight glycol with diisocyanate. Polyether and polyester block polyamide elastomers also can be used. The block copolymers have polyamide hard segments and either an aliphatic polyether or aliphatic polyester as soft segments.

The thermoplastic elastomers may also comprise mixtures of block copolymers as described above with polyolefins such as linear low density polyethylene (LLDPE) and low density polyethylene (LDPE). The useful low density ethylene polymers and copolymers range in densities of from about 0.880 to about 0.940. Specific examples of commercially available useful low density ethylene-1-octene copolymers include: Dowlex 2036A with a density in the range of 0.9330 to 0.9370; Dowlex 2032PER with a density of 0.9240 to 9280; Affinity PF1140 with a density of 0.895 to 0.898; Affinity VP8770 with a density of 0.885; Attane 4402 with a density of 0.912; and Attane 4401 with a density of 0.912. All of these copolymers are available from the Dow Chemical Co.

In one embodiment, the non-halogenated polymeric plasticizer is a nitrile rubber. In one embodiment, the non-halogenated polymeric plasticizer is a polymer of a diene and acrylonitrile. The nitrile rubber may be hydrogenated or non-hydrogenated. Hydrogenated nitrile rubbers include those manufactured by Nippon Zeon Co., Ltd. under a trade name of “Zetpol” and by Bayer under a trade name of “Therban”. Hydrogenated nitrile rubbers may have an iodine value of about 50% or less, or about 3 to about 40%, or from about 8 to about 30%, as the central value. Non-hydrogenated nitrile rubbers include those available under the trade name “N280” from Japan Synthetic Rubber Co., Ltd. and under trade names of “Nipol 1312” and “Nipol DN601” from Nippon Zeon Co., Ltd. Examples of commercially available nitrile rubbers include: the carboxyl terminated butadiene acrylonitrile liquid copolymers supplied by BFGoodrich under the tradename Hycar, specific examples including Hycar 1300X8, Hycar 1300X9 (a low molecular weight (Mn˜3,400) liquid butadiene/acrylonitrile copolymer (˜18% acrylonitrile content) containing pendant and terminal carboxyl groups (EPHR=0.072; 3.24% carboxyl content), Hycar 1300X13, Hycar 1300X18, Hycar 1300X19 (a low molecular weight (Brookfield Viscosity=490,000 cps at 27° C.; Mn˜3,000-4,000) liquid butadiene/acrylonitrile copolymer (˜16-17% acrylonitrile) containing pendant and terminal vinyl groups (EPHR vinyl group content=0.07) and Hycar 1300X31; and the polybutadiene polymers adducted with maleic anhydride supplied by Ricon Resins under the trade designations Ricon 131/MA-5, Ricon 131/MA-10, Ricon 131/MA-12 and Ricon 131/MA-17.

In one embodiment, the plasticizer is selected from olefin, diene and nitrile rubbers and copolymers and terpolymers thereof and those similar polymers having pendant reactive groups, especially carboxylic groups. In one embodiment, the diene-nitrile copolymers have carboxylic groups. A particularly useful rubber is acrylonitrile/butadiene rubber and those having carboxylic groups. In another embodiment, the carboxylic groups are provided by a termonomer such as methacrylic acid. In another embodiment, the plasticizer contains at least 1 wt %, or at least 2 wt %, or at least 2.25 wt % of carboxylic groups; or up to 5 wt % carboxylic groups. The carboxylic group content is expressed as a weight % derived from the molecular weight of a carboxyl group divided by the molecular weight of the length of polymer chain to which it is attached expressed as a percentage. This translates as follows: 1 wt % is equivalent to 1 carboxylic group per 4500 Mw (Mw=weight average molecular weight of the polymer chain); 2 wt % is equivalent to 1 per 2250 Mw; 2.25 wt % is equivalent to 1 per 2000 Mw. Useful plasticizers include the acrylonitrile/butadiene/methacrylic acid rubbers available from Nippon Zeon and B F Goodrich Company under the trade names Hycar and Nipol.

In another embodiment, the non-halogenated plasticizer is a thermoplastic copolymer or terpolymer derived from ethylene or propylene and a functional monomer selected from the group consisting of alkyl acrylate, acrylic acid, alkyl acrylic acid, and combinations of two or more thereof. In one embodiment, the functional monomer is selected from alkyl acrylate, acrylic acid, alkyl acrylic acid, and combinations of two ore more thereof.

The alkyl groups in the alkyl acrylates and the alkyl acrylic acids typically contain 1 to about 8 carbon atoms, and, in one embodiment, 1 to about 2 carbon atoms. The functional monomer(s) component of the copolymer or terpolymer ranges from about 1 to about 15 mole percent, and, in one embodiment, about 1 to about 10 mole percent of the copolymer or terpolymer molecule. Examples include: ethylene/methyl acrylate copolymers; ethylene/ethylacrylate copolymers; ethylene/butyl acrylate copolymers; ethylene/methacrylic acid copolymers; ethylene/acrylic acid copolymers; anhydride-modified low density polyethylenes; anhydride-modified linear low density polyethylene, and mixtures of two or more thereof.

Ethylene acid copolymers are available from DuPont under the tradename Nucrel. The ethylene/acrylic acid copolymers are available from Dow Chemical under the tradename Primacor. The ethylene/methyl acrylate copolymers are available from Chevron under the tradename EMAC. These include EMAC 2205, which has a methyl acrylate content of 20% by weight and a melting point of 83° C., and EMAC 2268, which has a methyl acrylate content of 24% by weight, a melting point of about 74° C. and a T_{g} of about −40.6° C.

In another embodiment, the polymeric plasticizer is a homopolymer or copolymer of vinyl acetate. Examples of these polymers include polyvinyl acetate, polyethylene vinyl acetate, acrylic acid or acrylate-modified ethylene vinyl acetate resins, acid-, anhydride- or acrylate-modified ethylene/vinyl acetate copolymers; acid- or anhydride-modified ethylene/acrylate copolymers. The ethylene-vinyl acetate copolymers may be manufactured by means known in the art from commercially available precursors and catalysts or obtained from commercial suppliers. The ethylene-vinyl acetate copolymers useful in the present invention include those with a vinyl acetate composition of about 18% to about 60%, or about 20% to about 40% by weight. Ethylene-vinyl acetate copolymers are commercially supplied by a number of manufacturers, including DuPont, Millennium Petrochemicals, Nova-Borealis Compounds LLC, AT Plastics Inc., Exxon, ATO Chem, Bayer AG, and others.

Examples of commercially available copolymers and terpolymers that can be used include the ethylene/vinyl acetate copolymers available from DuPont under the tradename Elvax. Other examples of commercially available EVA resins are available from Air Products & Chemicals, Inc., Allentown, Pa., under the AIRFLEX trademark. Examples include AIRFLEX 465® (65% solids) and AIRFLEX 7200® (72-74% solids). Another suitable EVA emulsion polymer is AIRFLEX 426®, a high solids, carboxylated, EVA polymer partially functionalized with carboxyl groups. It is believed that the AIRFLEX brand EVA emulsion polymers are stabilized with up to about 5% by weight polyvinyl alcohol (PVOH) and/or, in some formulations, a nonionic surfactant.

Examples of commercially available copolymers and terpolymers that can be used include the ethylene/vinyl acetate copolymers available from DuPont under the tradename Elvax. These include Elvax 3120 (7.5% vinyl acetate), Elvax 3124 (9% vinyl acetate), Elvax 3150 (15% vinyl acetate), Elvax 3174 (18% vinyl acetate), Elvax 3177 (20% vinyl acetate), Elvax 3190 (25% vinyl acetate), Elvax 3175 (28% vinyl acetate), Elvax 3180 (28% vinyl acetate), Elvax 3185 (33% vinyl acetate), and Elvax 3190LG (25% vinyl acetate) and a glass transition temperature (T_{g}) of about −38.6° C.). Other useful Elvax ethylene vinyl acetate copolymers include Elvax 40L-03, Elvax 450 (18% VA; MI=8); Elvax 460 (18% VA; MI=2.5); Elvax 470 (18% VA; MI=0.7); Elvax 350 (25% VA; MI=19); Elvax 360 (25% VA; MI=2); Elvax 240 (28% VA; MI=43); Elvax 250 (28% VA; MI=25); Elvax 260 (28% VA; MI=6); Elvax 265 (28% VA; MI=3); Elvax 150 (33% VA; MI=43); Elvax 40W (40% VA; MI=52); Elvax 46L (46% VA; MI=2.5); Elvax 46 (46% VA; MI=95).

In one embodiment, the polymeric plasticizer comprises an ethylene/vinyl acrylate terpolymer having an acid, for example methacrylic acid incorporated therein, then the polymer comprises at least about 1% acid, or from about 1% to about 12% by weight acid. One example of such a terpolymer is “BYNEL CXA 2002” from DuPont, a terpolymer comprising ethylene, n-butylacrylate, and methacrylic acid having a melt index of approximately 10.0 grams/10 minutes, a methacrylic acid content of about 10%, and an n-butylacrylate content of about 10%.

In one embodiment, the non-halogenated plasticizer comprises the polymerization product of a composition comprising ethylene, vinyl acrylate, and methacrylic acid, the polymer(s) having a vinyl acrylate content from about 10 to about 30 percent by weight and the acid content is about 1 to about 12 percent by weight based upon the total weight of the polymer(s).

In another embodiment, the non-halogenated plasticizer is a terpolymer derived a) an olefin, such as ethylene or propylene, b) a comonomer such as the above described acrylic acids and esters, methacrylic acids and esters and vinyl acetates, and c) carbon monoxide. A useful example of terpolymers are ethylene, vinyl acetate and carbon monoxide terpolymers. In one embodiment, the terpolymer comprises the polymerization product of a composition comprising (i) about 50 to about 88, or about 50 to about 77 percent by weight ethylene, (ii) about 10 to about 45, or about 18 to about 35 percent by weight of a monomer(s) selected from the group consisting of vinyl acetate, vinyl acrylate, and mixtures thereof, and (iii) about 2 to about 20, or about 5 to about 15 percent by weight carbon monoxide, wherein the weight percentages are based upon the total weight of the second polymer.

Examples of useful terpolymers include ELVALOY 742 (vinyl acetate content of about 28% and carbon monoxide content of about 9%), ELVALOY BP441 (n-butyl acrylate content of about 30% and carbon monoxide content of about 10%), and ELVALOY 4924 (vinyl acetate content of about 21% and carbon monoxide content of about 8%). Further examples of these polymers include Elvaloy 741, Elvaloy HP 443, Elvaloy HP 553, Elvaloy EP 4015, Elvaloy EP 4043, and Elvaloy EP 4051 (manufactured by Du Pont-Mitsui Polychemicals Co., Ltd. These polymers are available from DuPont.

The terpolymers are disclosed in U.S. Pat. No. 3,780,140 (Du Pont). Similarly WO 90/13600 (Du Pont) discloses ethylene/alkylacrylate/CO terpolymers as plasticizers which improve the processability of polyvinyl chloride. These references are incorporated by reference for their disclosures of the terpolymers and methods of making the same.

In another embodiment, the non-halogenated plasticizer (B) includes a polyolefin rubber, a polyisoprene rubber, a styrene-butadiene rubber, a styrene-isoprene rubber, a nitrile rubber, a butyl rubber, a silicone rubber, a polyacrylate rubber, an epichlorohydrin rubber, a fluoroelastomer, or a polyurethane.

Second Plasticizer

In one embodiment, the halogen containing film includes a second plasticizer. The second plasticizer (C) is typically present in an amount greater that about 80 parts per hundred parts of the vinyl halide polymer (A). Generally, the second plasticizer is present in an amount from about 80 to about 99.5, or from 85 to about 99, or from about 92 to about 98.5 parts per hundred parts of the total plasticizer content.

In one embodiment, the second plasticizer is an ester containing plasticizer. The plasticizer is a high-boiling solvent or softening agent, usually liquid. In one embodiment, it is an ester made from an anhydride or acid and a suitable alcohol that usually has between 6 to 13 carbon atoms. The plasticizers may be adipate, phosphate, benzoate or phthalate esters, polyalkylene oxides, sulfonamides, etc. The plasticizers include but are not limited to DOA plasticizer (Dioctyl adipate), TEG-EH plasticizer (Triethylene glycol di-2-ethylhexanoate), TOTM plasticizer (Trioctyl trimellitate), triacetin plasticizer (Glyceryl triacetate), TXIB plasticizer (2,2,4,-trimethyl-1,3-pentanediol diisobutyrate), DEP plasticizer (Diethyl phthalate), DOTP plasticizer (Dioctyl terephthalate), DMP plasticizer (Dimethyl phthalate), DOP plasticizer (Dioctyl phthalate), DBP plasticizer (Dibutyl phthalate), polyethylene oxide, toluenesulfonamide, dipropylene glycol benzoate, and the like.

In one embodiment, the second plasticizer is a polymeric plasticizer different from the non-halogenated polymeric plasticizer. These polymeric plasticizers include, but are not limited to, one or more of the following: polymeric/polyester adipate (such as EM-9776 from Emery Corporation), polymeric/polyester azelates (such as EM-9789 and EM-9790 from Emery Corporation), polyester adipate (such as PLR-100 from Huls America), and polyester sebacate (such as G-25 from C.P. Hall Corporation), polyester adipate (such as G-54 also from C.P. Hall), polyester adipate (such as G-59 and P-670 from C.P. Hall), polyester sebacate (such as P-1070 from C.P. Hall) and polyester adipate (such as Pallomal 656 from BASF).

The film may contain fillers such as pigments for color and strength as well as additives to protect against oxidation and ultraviolet radiation. Inorganic fillers may be included in the core to provide opaque films. Useful fillers include calcium carbonate, titanium dioxide and blends thereof.

A useful type of stabilizer is a hindered amine light stabilizer. Hindered amine light stabilizers are described in the literature such as in U.S. Pat. No. 4,721,531, Cols. 4-9. Such hindered amine light stabilizers may, for example, be derivatives of 2,2,6,6-tetraalkyl piperidines or substituted piperizinediones.

A number of hindered amine light stabilizers useful in the invention are available commercially such as from Ciba-Geigy Corporation under the general trade designations “Tinuvin” and “Chimassorb”; and from Cytec under the general designation “Cyasorb-UV.” Specific examples of useful hindered amine light stabilizers include Tinuvin 770 which is identified as bis-(2,2,6,6-tetramethyl-4-piperidinyl)-sebacate; Tinuvin 765 which is identified as bis-(1,2,2,6,6-pentamethyl-4-piperidinyl)-sebacate; Tinuvin 144 which is bis-(1,2,2,6,6-pentamethyl-4-piperidinyl)-2-n-butyl-2-(3′5′-di-tert-butyl-4-hydroxy-benzyl) malonate; Tinuvin 622 which is a polyester of succinic acid and N-beta-hydroxy ethyl-2,2,6,6-tetramethyl-4-hydroxy-piperidine; and Chimassorb 944 which is poly-6-(1,1,3,3-tetramethylbutyl) amino-s-triazine-2,4diyl-2,2,6,6-tetramethyl-4-piperidyl)imino hexamethylene (2,2,6,6-tetramethyl-4-piperidyl)imino.

The vinyl halide film layer also may contain at least one hindered phenolic antioxidant compound. Useful hindered phenolic antioxidant compounds are known in the art and are described in, for example, U.S. Pat. No. 4,721,531, Cols. 13-14. U.S. Pat. No. 4,721,531 is hereby incorporated by reference for its disclosure of such hindered phenolic antioxidant compounds. Any of the hindered phenolic antioxidant compounds disclosed in the '531 patent can be utilized in the vinyl halide films of the present invention. Some of the hindered phenolic antioxidant compounds are available commercially from Ciba-Geigy under the general trade designations “IRGANOX” and “Tinuvin.” Specific examples include IRGANOX 1076 which is believed to be n-octadecyl-3-(3′5′-di-t-butyl-4′-hydroxyphenyl) propanoate; IRGANOX 1010 which is 2,2-bis-(3-(3,5-bis(1,1-dimethylethyl-4-hydroxyphenyl-1-oxopropoxymethyl-1,3-propanediyl-3,5-bis(1,1-dimethyleth-yl)-4-hydroxy benzene propanoate; Tinuvin 326 which is 2-(5-chloro-2H-benzotriazol-2-yl)-6-(1,1-dimethylethyl)-4-methylphenol; and Tinuvin 328 which is 2(2′-hydroxy-3′,5′-di-t-amylphenyl)benzotriazole.

The above discussion of antioxidants, light stabilizers and ultraviolet stabilizers is not intended to be limiting as other examples of hindered phenolic antioxidants and hindered amine light stabilizers can be utilized. For example, a variety of ultraviolet absorbers can be utilized and include benzotriazol derivatives, hydroxy benzophenones, esters of benzoic acids, oxalic acid, diamides, etc. The amounts of the heat light stabilizers, and the amounts of antioxidants incorporated into the films of the present invention will be an amount that will be sufficient when blended into the film to provide the desired stabilization. In general, the vinyl halide film layer (and other layers) of the invention may contain from 0.001% to about 0.5% by weight of one or more stabilizers such as antioxidants, UV stabilizers and absorbers, light stabilizers, etc.

In one embodiment, the vinyl halide film material contains an effective amount of a processing aid to facilitate extrusion. While not wishing to be bound by theory, it is believed that these processing aids have a high affinity to metal surfaces and thereby prevent or reduce the tendency of the polymer compositions being extruded from adhering to the inner walls of the extrusion equipment. The addition of processing aid makes it easier to purge the extrusion equipment during color changeovers. These processing aids include acrylic polymers such as polymethylmethacrylate (PMMA) and hexafluorocarbon polymers, such as Ampacet 10919 commercially available from Ampacet Corporation. The processing aids are typically used at concentrations of up to 0.25 parts per 100 parts of the total vinyl halide film material, and in one embodiment, about 0.03 to about 0.15 parts per 100 parts of the total vinyl halide film material.

In addition to pigments and fillers, UV stabilizers, and processing aids, the vinyl halide film material may include the thermal stabilizers, anti-static additives, anti-block and/or anti-slip additives and anti-oxidants. A representative, non-limiting list of thermal stabilizers include iron oxide, metallic powders such as aluminum and zinc, and compounds such as cerium hydrate and barium zirconate.

Description of Film Preparation

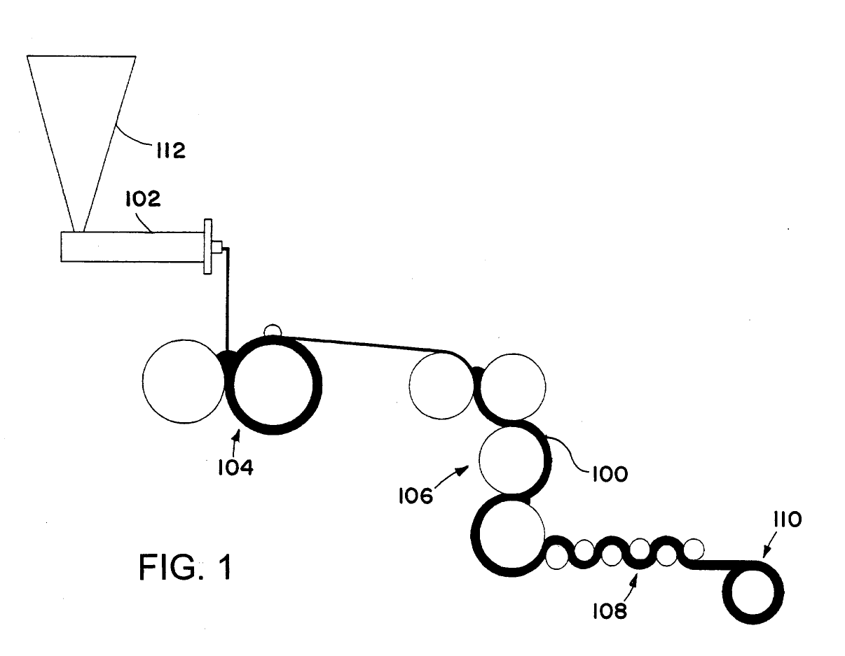

The vinyl halide film is prepared on a L-type calender. Referring to FIG. 1, a calendering process for making the vinyl halide film 100 of the present invention is disclosed. The apparatus used in this process includes a co-kneader 102, a 2-roll mill 104, a calendering section 106, and a tempering unit 108. The dry-blend of raw materials is fed from hopper 112 to co-kneader 102 where the dry-blend is homogenized at a temperature of approximately 175° C. The homogeneous half-molten plastic is fed to 2-roll mill 104, where further homogenization takes place at a temperature of 170° C. From the 2-roll mill 104, the melt is fed to the calender section 106, where the plastic film is formed by means of a number of steel cylinders. During this step the temperatures vary between 170° C. and 200° C. After the calender section 106, the film 100 is moved through tempering unit 108 in order to cool it down and remove any stress from the film 100. The average running speed depends on the film thickness, film width and equipment used, and can vary between 80 to 120 meters per minute in the case of a 70 micrometers thick film.

### EXAMPLE 1

The following formulation of a vinyl halide polymeric material was fed into a hopper for extrusion coating followed by calendering to produce the resulting film.

| Ingredients | Parts |
|---|---|
| PVC (K-64) | 65 |
| PVC (K-58) | 35 |
| ethylene, vinyl acetate, carbon monoxide terpolymer, | 2 |
| Elvaloy 742 (DuPont) | |
| adipic polymer plasticizer, Palamoll 652 (BASF) | 30 |
| Benzophenone UV absorber | 3 |
| barium zinc thermal stabilizer, Baerostab BZ 8780 | 3 |
| Acrylic processing aid, Paraloid K125 (PMMA) | 2 |

The film may be used to prepare graphics adhesive articles. The film is adhered to an adhesive, such as a pressure sensitive adhesive or a heat-activated adhesive. These adhesives are known to those in the art, and include acrylate based adhesives, natural rubber based adhesives, synthetic rubber based adhesives, such as polystyrene polybutadiene, ethylene vinyl acetates, synthetic rubber adhesives based on block copolymers, such as polystyrene polybutadiene polystyrene and polystyrene polyisoprene polystyrene, vinyl ether based adhesives, silicon based adhesives, polyurethane based adhesives, etc. On the other side of the adhesive, opposite the PVC film side, the adhesive is releasably adhered to a release liner, such as a silicone treated paper.

In one embodiment, an adhesive will be coated onto a release paper and dried in an oven. When the adhesive leaves the oven, the PVC film made in an earlier stage is laminated against the adhesive, resulting in a construction of release paper/adhesive/PVC film/casting paper. In a final step the casting paper is stripped and the film is cut into its final size.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. A calendered vinyl halide film comprising (A) at least one vinyl halide polymer; (B) at least one non-halogenated polymeric plasticizer; and (C) at least one second plasticizer different from the non-halogenated polymeric plasticizer (B); wherein a major amount of the polymers of the film comprise the vinyl halide polymer (A) and wherein the film has an elongation of at least about 50%.

2. The film of claim 1 wherein (A) is a homopolymer or copolymer of at least one vinyl chloride.

3. The film of claim 1 wherein (A) is at least one polyvinyl chloride.

4. The film of claim 1 wherein the non-halogenated polymeric plasticizer (B) is a natural or synthetic rubber.

5. The film of claim 1 wherein (B) is a polybutadiene rubber, a polyisoprene rubber, a styrene-butadiene rubber, a styrene-isoprene rubber, a nitrile rubber, a butyl rubber, an ethylene-propylene terpolymer, a silicone rubber, a polyacrylate rubber, an epichlorohydrin rubber, a fluoroelastomer, or a polyurethane.

6. The film of claim 1 wherein (B) is a nitrile rubber.

7. The film of claim 1 wherein (B) is present in an amount of less than 20 parts per hundred parts of (A).

8. The film of claim 1 wherein (C) comprises an ester.

9. The film of claim 1 further comprising at least one pigment.

10. The film of claim 1 wherein (C) is present in an amount from about 80 to about 99.5 parts per hundred parts of total plasticizer.

11. A calendered vinyl halide film comprising (A) at least one polyvinyl chloride; (B) at least one non-halogenated rubber polymeric plasticizer; and (C) at least one second plasticizer different from the non-halogenated polymeric plasticizer; wherein the film has an elongation of at least about 50%.

12. The film of claim 11 wherein (B) is a nitrile rubber.

13. The film of claim 11 wherein (B) is present in an amount of less than 15 parts per hundred parts of (A).

14. The film of claim 11 further comprising at least one pigment.

15. The film of claim 11 wherein (C) comprises an ester.

16. The film of claim 11 wherein (C) is present in an amount from about 85 to about 99 parts per hundred parts of total plasticizer.

17. An adhesive article comprising a pressure sensitive adhesive layer having a first and second surface, and a calendered vinyl halide film adhered to the first surface of the adhesive layer, wherein the vinyl halide film comprises (A) at least one vinyl halide polymer; (B) at least one non-halogenated polymeric plasticizer; and (C) at least one second plasticizer different from the non-halogenated polymeric plasticizer; wherein the adhesive article has an elongation of at least about 50%.

18. The adhesive article of claim 17 wherein the vinyl halide polymer (A) is a homopolymer or copolymer of at least one vinyl chloride.

19. The adhesive article of claim 18 wherein (A) is at least one polyvinyl chloride.

20. The adhesive article of claim 19 wherein the non-halogenated polymeric plasticizer (B) is a natural or synthetic rubber.

21. The adhesive article of claim 19 wherein (B) is a polybutadiene rubber, a polyisoprene rubber, a styrene-butadiene rubber, a styrene-isoprene rubber, a nitrile rubber, a butyl rubber, an ethylene-propylene terpolymer, a silicone rubber, a polyacrylate rubber, an epichlorohydrin rubber, a fluoroelastomer, or a polyurethane.

22. The adhesive article of claim 17 wherein (B) is at least one nitrile rubber.

23. The adhesive article of claim 17 further comprising at least one pigment.

24. The adhesive article of claim 17 wherein (C) comprises an ester.
